(19) United States
(12) Patent Application Publication
(10) Pub. No.: US 2025/0067122 A1
(43) Pub. Date: Feb. 27, 2025

(54) DEVICE FOR SEPARATING PERSONS AND/OR VEHICLES

(71) Applicant: ELKA TORANTRIEBE GMBH U. CO. BETRIEBS KG, Tönning (DE)

(72) Inventor: TORBEN NEHLS-ELLER, MILDSTEDT (DE)

(73) Assignee: ELKA TORANTRIEBE GMBH U. CO. BETRIEBS KG, TOENNING (DE)

(21) Appl. No.: 18/726,796

(22) PCT Filed: Jan. 5, 2023
(86) PCT No.: PCT/DE2023/200001

§ 371 Date: Jul. 4, 2024

(30) Foreign Application Priority Data
Jan. 7, 2022 (DE) 10 2022 100 279.9

(51) Int. Cl. E06B 11/08; E01F 13/06

(52) U.S. Cl. CPC E06B 11/08; E01F 13/06

(57) ABSTRACT

A device for separating persons and/or vehicles in a separating region. The device includes a stationary holding apparatus, a receiving portion which rotates in a rotational plane about a rotational axis relative to the holding apparatus, at least one blocking beam, and a lighting apparatus. The receiving portion has at least one blocking beam receiving portion. The lighting apparatus has a light source assigned to the at least one blocking beam. The light source generates a light marker and marks a relevant blocking beam. A blocking beam is received in a relevant blocking beam receiving portion so that, when the rotational receiving portion rotates, the blocking beam pivots out of the separating region to separate a person/vehicle from other persons/vehicles upon a passage or a transit through the separating region.

### CROSS REFERENCE TO PRIOR APPLICATIONS

This application is a U.S. National Phase application under 35 U.S.C. § 371 of International Application No. PCT/DE2023/200001, filed on Jan. 5, 2023 and which claims benefit to German Patent Application No. 10 2022 100 279.9, filed on Jan. 7, 2022. The International Application was published in German on Jul. 13, 2023 as WO 2023/131381 A1 under PCT Article 21(2).

### FIELD

The present invention relates to a device for separating persons and/or vehicles in a separating region, the device comprising a holding apparatus which can be installed in a stationary manner, a rotational receiving portion which can be rotated in a rotational plane about a rotational axis relative to the holding apparatus, and at least one blocking beam, the at least one blocking beam being received in a relevant blocking beam receiving portion of the rotational receiving portion corresponding to the relevant blocking beam so that, when the rotational receiving portion rotates in the rotational plane about the rotational axis, the at least one blocking beam is pivoted out of the separating region and a person and/or a vehicle can thus be separated from other persons and/or other vehicles upon passage or transit through the separating region.

### BACKGROUND

Known devices for separating persons and/or vehicles, such as turnstiles or car-park barriers, usually comprise signal apparatuses which are arranged separately from the respective blocking beams, for example, on a signal pillar. It is, however, helpful for these persons and/or vehicles if a transit status or the option of transit can, for example, be immediately and clearly identified for a system of this kind.

### SUMMARY

An aspect of the present invention is to improve upon the prior art.

In an embodiment, the present invention provides a device for separating at least one of persons and vehicles in a separating region. The device includes a holding apparatus which is installable in a stationary manner, a rotational receiving portion which is rotatable in a rotational plane about a rotational axis relative to the holding apparatus, at least one blocking beam, and a lighting apparatus. The rotational receiving portion comprises at least one blocking beam receiving portion. The lighting apparatus comprises a light source which is assigned to the at least one blocking beam. The light source is configured to generate a light marker in an activated state and is arranged to mark a relevant blocking beam of the at least one blocking beam. The at least one blocking beam is configured to be received in a relevant blocking beam receiving portion of the at least one blocking beam receiving portion of the rotational receiving portion corresponding to the relevant blocking beam of the at least one blocking beam so that, when the rotational receiving portion rotates in the rotational plane about the rotational axis, the at least one blocking beam is pivoted out of the separating region so that at least one of a person and a vehicle can be separated from at least one of other persons and other vehicles upon a passage or a transit through the separating region.

### BRIEF DESCRIPTION OF THE DRAWINGS

The present invention is described in greater detail below on the basis of embodiments and of the drawings in which:

FIG. 1 is a schematic front view of a turnstile system comprising a turnstile, a passage, and a lighting module;

FIG. 2 is a schematic plan view of the lighting module from FIG. 1;

FIG. 3 is a schematic view of a turnstile system comprising a turnstile, a passage, and a lighting module arranged in the blocking beam;

FIG. 4 is a schematic view of a barrier system comprising a barrier and a luminous surface; and

FIG. 5 is a sectional side view of a detail of a rotational receiving portion of the barrier system from FIG. 4.

### DETAILED DESCRIPTION

The present invention provides a device for separating persons and/or vehicles in a separating region, the device comprising a holding apparatus which can be installed in a stationary manner, a rotational receiving portion which can be rotated in a rotational plane about a rotational axis relative to the holding apparatus, and at least one blocking beam, the at least one blocking beam being received in a relevant blocking beam receiving portion of the rotational receiving portion corresponding to the relevant blocking beam so that, when the rotational receiving portion rotates in the rotational plane about the rotational axis, the at least one blocking beam is pivoted out of the separating region and a person and/or a vehicle can thus be separated from other persons and/or other vehicles upon passage or transit through the separating region, wherein a lighting apparatus comprising a light source is assigned to the at least one blocking beam, and in an activated state of the light source, a light marker is generated by the light source and the generated light marker marks the relevant blocking beam.

Immediate identifiability can be provided by the light marker being identifiable on the blocking beam and being generated by the light source via the present invention. A person or vehicle driver can thereby, for example, identify directly on the blocking beam whether transit is possible or whether, for example, an action, such as registering via a magnetic card, is required.

The following terms are here explained.

A “device for separating persons and/or vehicles” is a device that makes it possible to separate persons in a separating region from other persons, for example, from a group of persons, or to separate vehicles from other vehicles. One such device is, for example, a turnstile, which is arranged at a separating region and thus, using corresponding blocking beams, serves to separate one person from a group. A separating device of this kind can also be a retrofit device in order to supplement, for example, a passage or entrance to a corresponding area of usage around a separating region with a corresponding device. A device can also be designed as a barrier, for example, for separating off a car park.

A “separating region” is the region along a passage or transit, for example, in which the persons and/or vehicles are separated physically. A separating region of this kind is, for example, arranged in a narrow passage so that the device for separating persons reaches into the passage and therefore turns the passage into a separating region. A separating region of this kind can, for example, be an entrance to a swimming pool, an event, or company or factory premises, so that the entrance to these facilities is regulated using the device for separating persons. Similarly, for vehicles, the separating region has different dimensions, depending on the application, but its effect is the same. A corresponding “region” can, for example, also be defined by a time sequence, for example, by an opening time of the relevant blocking beam. A separating region for a vehicle can, for example, be defined by a time window in which one vehicle can usually drive through this physical separating region, but another vehicle no longer can. It should here be noted that a vehicle can be both a motor vehicle and, for example, a bicycle, a velomobile or a comparable human-powered vehicle.

A “holding apparatus” is the component of the device for separating persons which is, for example, installed on a holding point, a wall, or a receiving portion, in order to orient the device for separating persons in the correct position and the correct angular orientation in accordance with its intended function. “Can be installed in a stationary manner” describes that a holding apparatus of this kind is installed in a wall or on the ground, for example, via screws and wall plugs, so that a stationary position of the device for separating persons and/or vehicles is obtained relative to the environment, for example, relative to the structure.

A “rotational receiving portion” describes the component of the device for separating persons and/or vehicles which is arranged to be rotatable relative to the holding apparatus, namely, in a rotational plane about a rotational axis. A rotational receiving portion of this kind also serves to receive a blocking beam or corresponding blocking beams in this case. A “rotational plane” is here the plane in which rotation of the rotational receiving portion relative to the holding apparatus takes place, and by contrast, the “rotational axis” is orthogonal to the rotational plane so that the six degrees of freedom of the rotational receiving portion are geometrically assigned via the rotational plane and the rotational axis. Only some degrees of freedom of the six available degrees of freedom are used in practice, for example, the rotation about the rotational receiving portion and in particular a corresponding, usually coupled, movement of a blocking beam or a plurality of blocking beams. The corresponding rotational plane and likewise the rotational axis are in this case mathematically idealized and can have technically induced deviations both in their orientation and in their straightness so that, for example, a rotational axis is defined in that the rotational receiving portion is rotatable about a support and, in so doing, has a certain tolerance in relation to the mathematically exact axis.

A “blocking beam” can be a bar-shaped or a frame-shaped arrangement on the device for separating persons and/or vehicles which is received on the rotational receiving portion. A device of this kind for separating persons usually comprises two or even more blocking beams, for example, a corresponding turnstile comprises three blocking beams, while four, five or six blocking beams can be provided in accordingly larger devices or accordingly larger systems comprising devices of this kind. Devices comprising just one blocking beam, for example, in the form of a barrier, are also known for vehicles and for persons. In this case, a blocking beam of this kind is, for example, formed by a tube or a round or differently shaped, usually prismatic, base material. A blocking beam of this kind does not need to consist of a single piece, but can also be designed as a U-shaped frame, for example, in order to make it possible to deploy a larger area against a person to be separated or to prevent particularly low vehicles from transiting through.

A “blocking beam receiving portion” is, for example, a support or a differently designed receiving portion for a relevant blocking beam on the rotational receiving portion so that the blocking beam is arranged to be fixed relative to the rotational receiving portion in some degrees of freedom via the blocking beam receiving portion, but retains at least one degree of freedom so that, for example, a relevant blocking beam is designed to be rotatable or pivotable relative to the rotational receiving portion.

Here, “corresponding” describes that a corresponding end region of a blocking beam and a blocking beam receiving portion assigned to the blocking beam in question are designed to fit geometrically to one another so that the blocking beam can be physically received in the blocking beam receiving portion.

A “rotation” of the rotational receiving portion describes the process in which the device for separating persons and/or vehicles is put into operation, namely, the rotational receiving portion and therefore also the corresponding blocking beams are rotationally moved about the rotational axis. For example, a turnstile is rotated for separating persons or a barrier is pivoted to demarcate a car park.

The process whereby one of the blocking beams is “pivoted out” of the separating region and, for example, another blocking beam is “pivoted into” the separating region is described in that a relevant blocking beam is physically guided out of the separating region and, for example, another of the blocking beams is physically guided into the separating region so that the blocking beam that has been pivoted into the separating region can serve to separate a person, while a blocking beam that has been pivoted out of the separating region clears an onward path for a person who has, for example, just been separated.

The “passage” of a person describes the physical action by the person of moving through the separating region, for example, on foot. By contrast, the term “transit” can mean a vehicle physically passing through the separating region.

A “lighting apparatus” is in particular a technical apparatus which provides lighting, i.e., emits light, via respective components. A lighting apparatus of this kind comprises a “light source”, i.e., for example, an LED, a lightbulb, or another source of visible or invisible light. It should here be noted that the light source can also be configured to emit light in particular in the infrared or ultraviolet range so that, for example, a corresponding light marker can be generated via thermal radiation (IR) or ultraviolet light (UV), in particular also by fluorescence and/or heat generation initiated by light of a particular wavelength. A “light marker” of this kind describes the light emission that is actually used to mark the relevant blocking beam and can, for example, be identified and perceived by the person or by a person driving a vehicle. It should be noted there that the light source and light marker can expressly also be situated at different locations from one another. The lighting apparatus can, for example, also comprise an “optical waveguide”, i.e., an apparatus for conducting and/or guiding light from the light source to the point at which the light marker is generated by a total reflection on boundary surfaces of the optical waveguide in order for it to be possible to position the light source at a separate location.

In order for it to be possible to implement a technically simple and locally limited light marker, the light source is arranged inside the relevant blocking beam and/or on the relevant blocking beam, the light marker being generated directly via the light source and the relevant blocking beam being marked.

The light source, i.e., an LED marker, can, for example, be arranged directly on the blocking beam so that the corresponding thus generated light marker is directly perceptible from the light source.

“Inside” the relevant blocking beam describes an arrangement inside a cavity in a blocking beam, for example, the blocking beam being able to be constructed as an extruded profile or generally, for example, as a tube in this case. “On” the relevant blocking beam, however, describes an arrangement on an outer surface of the blocking beam, i.e., on a side or a corresponding region of the blocking beam that is, for example, directly visually and also mechanically accessible to a person.

In an embodiment of the present invention, the light source can, for example, be arranged outside the relevant blocking beam and/or separately from the relevant blocking beam, in particular arranged on the holding apparatus and/or on the rotational receiving portion, and in the activated state, the light source projects the light marker onto the relevant blocking beam so that the relevant blocking beam is marked by the projected light marker.

Any potential soiling of the blocking beam can thus be counteracted, for example, in the form of indirect lighting and/or projection. A corresponding projection also makes it possible for a blocking beam covered, for example, with snow or other precipitation, for example, to still be effectively marked and to be provided with a corresponding light marker since, in this case, the snow or the other precipitation actively reproduces the light marker.

It should be noted that in this case, an arrangement of the light source inside the ground, for example, i.e., underneath the relevant blocking beam, is also possible so that, in particular, a mixed marker made up of the projection onto the relevant blocking beam by the light source and a further direct light marker in the ground inside a light source or an arrangement having a plurality of light sources can also be facilitated. The same applies to another location at which the light source can be arranged.

“Separately” from the relevant blocking beam in particular denotes the arrangement of the light source at a physical distance from the blocking beam, i.e., in a component of the device other than the blocking beam. The light marker is projected onto the relevant blocking beam as a result. “Projected” in particular denotes the emission of light from the light source over a distance so that the light marker is visible on the blocking beam in the form of indirect lighting. For this purpose, the blocking beam can, for example, also comprise a projection surface that is constructed to be specially adapted for the light from the light source so that, for example, a particularly clear light marker can be identified on the projection surface. A projection surface of this kind can, for example, be equipped with a corresponding marker having a heat signature and/or a fluorescence signature, for example, in the form of a white surface, a surface having specific dullness of the surface, or also an interactive projection surface for the absorption of infrared light or also ultraviolet light.

The “projected light marker” describes the light marker that is visible to the person or to a person driving a vehicle, for example, which arises from projecting corresponding light from the light source onto the blocking beam.

It should also be noted that, according to the present invention, a combination of a directly generated light marker and a projected light marker is possible. A directly generated light marker can, for example, also be enhanced and/or supplemented by a projected light marker, and this also applies in reverse.

In order to be able to use the light source as required, the light source comprises a control apparatus, the control apparatus comprising a position sensor and the light source being marked by the control apparatus on the basis of a blocking beam position of the relevant blocking beam recorded by the position sensor. Alternatively, and/or additionally, the light source can also be marked on the basis of an operating state of the device by the control apparatus.

A “control apparatus” can here be a technical apparatus which is suitable for accordingly influencing the light source and/or a path of the light from the light source to the light marker. A “position sensor” can here be constructed as a conventional sensor within the meaning of an electronic component as well as mechanical switching and/or a mechanical apparatus for implementing a function similarly to a sensor. The position sensor can also be reproduced by reading out a motor signal, for example, an electronically commutated motor so that a separate, physical position sensor can in particular be omitted.

The control apparatus is in particular configured to provide electrical, electronic, mechanical and/or optical control, in particular an opto-mechanically controlling control apparatus is arranged in the rotational receiving portion so that, when an optical waveguide of the control apparatus assigned to the light source is combined with an optical waveguide assigned to the light marker, as is done on the basis of a rotational position of the rotational receiving portion, the light marker is generated by guiding the light from the light source to the light marker.

Combining the respective optical waveguides can in this case have an effect in the sense of a position sensor since light is guided expressly only when corresponding optical waveguide surfaces are at least partially covered up so that only then is a corresponding light marker generated. A corresponding optical switching apparatus can, for example, be provided inside the rotational receiving portion which, for example, lights up a blocking beam in one color in the blocked position and lights up the same blocking beam in another color when it has rotated into an open position.

In an embodiment of the present invention, the light source can, for example, be multi-colored so that a multi-colored light marker is generated, in particular can be switched by the control apparatus.

A multi-colored light source of this kind can, for example, be constructed both as a multi-colored LED and as a light source that is switched via colored control discs, for example.

In an embodiment of the present invention, the light source can, for example, be designed to generate a light marker in the form of a text display and/or an image display.

A “text display” is a display of legible letters or characters, and it is unimportant here what language or writing system this is in. This also includes the display of numbers or numerical characters. An “image display” is, for example, suitable for displaying freely configurable images, such as pixel arrays. In particular in connection with a projected light marker, this provides considerable potential in terms of markers, displaying standard text, reproducing information and, for example, displaying text relating to the operating state of the device.

The light source can in particular comprise an LED light source, a laser light source and/or a projection light source. LED light sources are here well known and are a simple, power-saving option for displaying different colors. A laser light source can, for example, also be used to provide an accordingly focused and precise display via directed light. A “projection light source” can display respective specific characters, such as corporate branding or an advertisement, in the mode of operation of a conventional image projector or, for example, by projecting templates.

In an embodiment of the present invention, the at least one blocking beam can, for example, be a barrier, in particular a barrier for separating vehicles.

In an embodiment of the present invention, the device can, for example, comprise at least two blocking beams, the at least one blocking beam being pivoted out of the separating region and another of the blocking beams being pivoted into the separating region when the rotational receiving portion rotates in the rotational plane about the rotational axis so that one person can be separated from other persons via the blocking beams. Apparatuses of this kind comprising at least two blocking beams are generally also known as turnstiles.

The present invention will be explained in greater detail below on the basis of exemplary embodiments as shown in the drawings.

A turnstile system 101 is constructed on the ground 103 close to a wall 105. The turnstile system 101 comprises a pillar 107 which delimits a passage 109 formed between the pillar 107 and the wall 105. The pillar 107 comprises an installation surface 121 which is arranged to be inclined relative to the vertical by the angle 123. The angle 123 is an angle of 45° in the shown example. The installation surface 121 is here inclined so that an upper region of the installation surface 121 is closer to the wall 105 than a lower region, and the installation surface 121 is thus formed as an undercut in the pillar 107. The pillar 107 can be designed to be height-adjustable, for example, telescoping, for variably adjusting a height of a turnstile 111 in the passage 109.

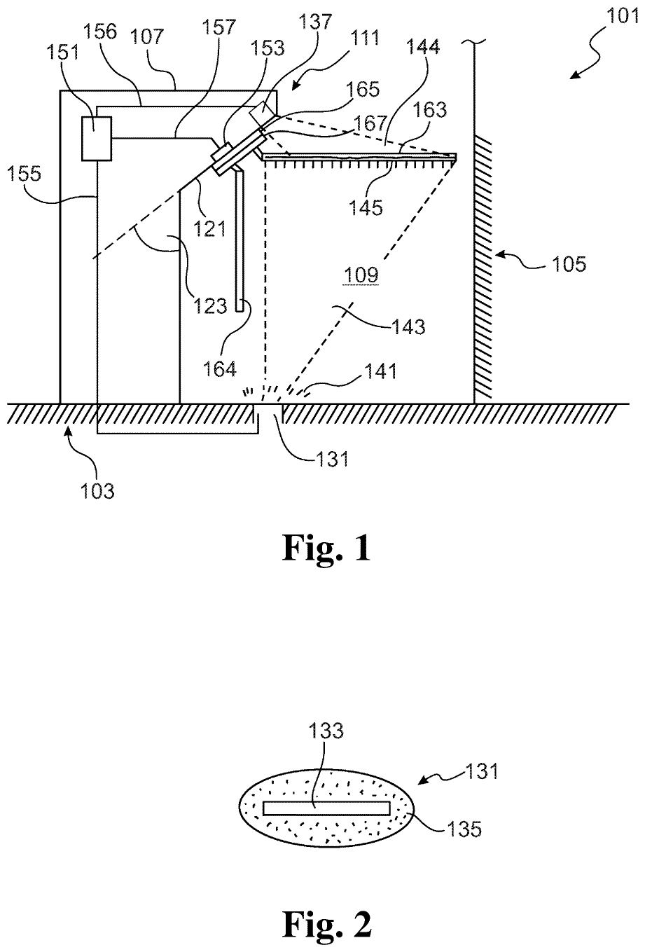

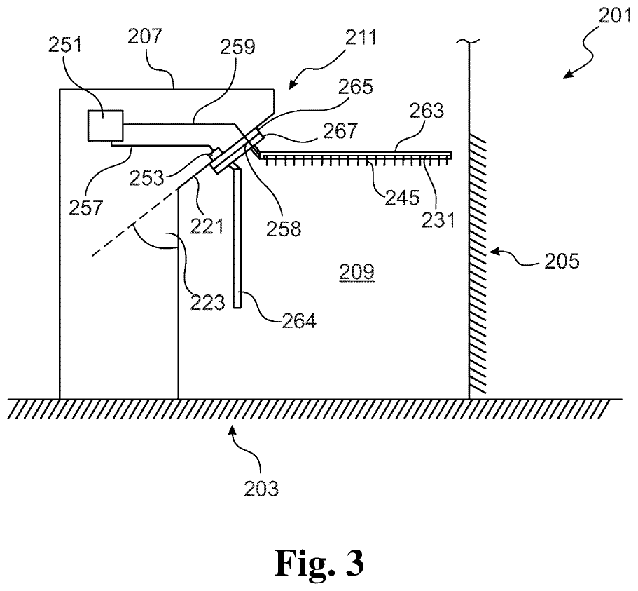

The turnstile 111 is received on an installation surface 121 in a stationary manner. For this purpose, a base plate 165 of the turnstile 111 is securely screwed to the installation surface 121. A hub 167 is rotatably received on the base plate 165, the hub 167 bearing a plurality of blocking beams. In the shown example, three blocking beams are evenly distributed over a circumference of the hub 167, and specifically so that one blocking beam 163 is arranged in the passage 109 and, when the hub 167 rotates relative to the base plate 165, another blocking beam 164 is pivoted into the passage 109, and the blocking beam 163 that was previously in the passage 109 is pivoted out of the passage 109. By rotating the turnstile 111, persons can thus be separated in the passage 109 via the blocking beams 163, 164 and the third blocking beam (which is concealed by the blocking beam 164 in FIG. 1).

A lighting module 131 is arranged in the ground 103 and more or less underneath the arrangement made up of the base plate 165 and the hub 167, which lighting module 131 is almost completely recessed into the ground 103. The lighting module 131 comprises a luminous bar 133 and a luminous surface 135 arranged in the direction of the blocking beam 163. The luminous surface 135 is opaque, for example, rough, so that a light signal 141 can be displayed in the region of the ground 103. Via the luminous bar 133, a narrow, focused luminous cone 143 can be emitted in the direction of the blocking beam 163, via which a light marker 145 can be projected onto the blocking beam 163. The luminous bar 133 can, for example, be formed by a lens, which forms a gap-shaped passage for the luminous cone 143. The light signal 141 and the light marker 145 can likewise be displayed in different colors and/or at different wavelengths. It should here be noted that the lighting via a light signal 141, in particular via the light marker 145 on the blocking beam 163, is here provided by way of example and that text components or image displays can, for example, also be projected onto the blocking beam 163, provided that the lighting module 131 is not designed merely as a light source, but also, for example, as a projection unit or a laser projection unit. Lighting via UV light and/or IR light is also possible so that, for example, a fluorescent surface on the blocking beam 163 can be stimulated via UV light and/or a heat signature can be generated via IR light on the surface of the blocking beam. Similarly, alternatively or additionally, a lighting module 137 can be arranged in the pillar 107, which, for example, lights up the blocking beam 163 with a luminous cone 144 from an upper side (see FIG. 1) or from another direction. This function can be configured similarly to the lighting module 131, but, when the blocking beam 163 is lit up from above, a luminous surface similar to the luminous surface 135 can also be omitted, for example, and only focused lighting directly onto the blocking beam 163 is provided, similarly to the function of the luminous bar 133.

A controller 151 in the pillar 107 controls the lighting module 131 via a cable 155, and a rotary sensor 153 is also connected to the controller 151 via a cable 157. A rotational position of the turnstile 111 can be recorded via the rotary sensor 153 so that the controller 151 projects colored lighting onto the blocking beam 163, for example, on the basis of the rotational position. It should here be noted that, for example, reading out a closed control loop of a drive motor can also be used to determine the rotational position so that the rotary sensor 153 can, for example, be omitted. This applies, for example, to a brushless, electronically commutated drive motor. Similarly to the luminous cone 143, an alternative or additional luminous cone can also be used to light up a blocking beam 164 that is not, for example, located within the passage 109.

An alternative turnstile system 201 is installed on the ground 203 and on a wall 205, similarly to the previous example. A pillar 207 thus separates a passage 209 from the wall 205. A turnstile 211 is installed on an installation surface 221 arranged at an angle 223, similarly to the previous example. For this purpose, blocking beams 263 and 264 as well as another blocking beam (not visible) are received in a rotational receiving portion 267 to be rotatable on a base plate 265, which is installed along the installation surface 221.

The blocking beam 263 and also other blocking beams comprise a lighting module 231 which is directly integrated in the blocking beam. The lighting module 231 can display a direct light marker 245 in the relevant blocking beam, in this case, in the blocking beam 263 by way of example. For this purpose, a cable 259 from a controller 251 is connected to the lighting module 231 via a slip ring 258. Via a cable 257, a rotary sensor 253 having a similar function to the previous example is connected to the controller 251.

It should here be noted that the slip ring 258 in FIG. 2 is described and shown as functioning together with the blocking beam 263 by way of example, but a connection of the blocking beam 263 or the third blocking beam which is, for example, on the basis of the angle of rotation, can also be implemented by accordingly positioning the slip ring contacts around the point of rotation of the rotational receiving portion 267. The slip ring can alternatively also be replaced with or supplemented by a system for contactlessly transferring energy, for example, via an arrangement for inductively transferring electrical energy so that the components for generating the light are completely arranged, for example, in the blocking beam. Here and also for the other shown examples, an angle of rotation can, for example, also be determined via sensors that are found in the system anyway, for example, Hall sensors.

A barrier system 301 is arranged above the ground 303 relative to a post 305 and is used to block off a car park. The barrier system 301 comprises a pillar 307 which delimits the passage 309 at the sides relative to the post 305. A barrier 311 is received via a rotational receiving portion 364 on the pillar 307. The rotational receiving portion 364 consists of a base plate 365 and a rotary plate 367, the rotary plate 367 being arranged to be rotatable relative to the base plate 365. The base plate 365 forms the mechanical connection to the pillar 307.

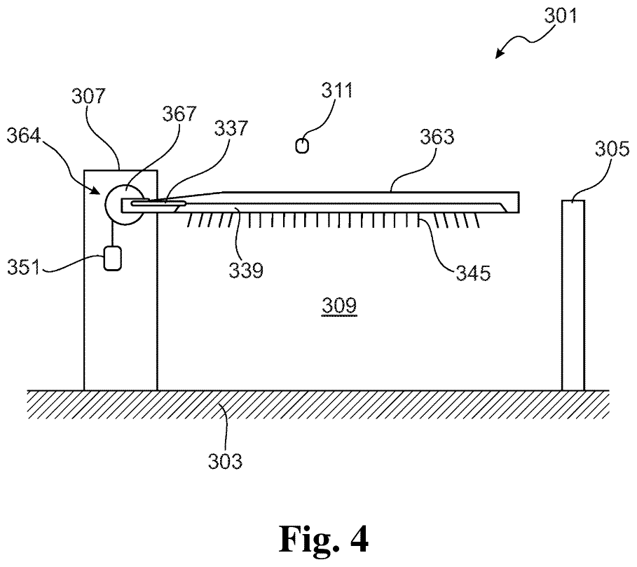

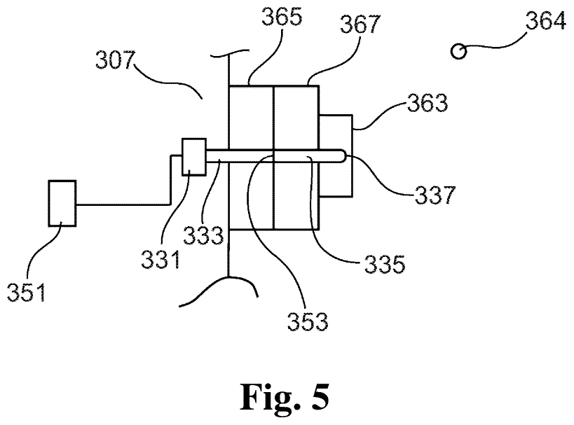

The barrier 311 comprises a blocking beam 363 formed as a barrier boom, which comprises a luminous surface 339. The luminous surface 339 is designed as a translucent optical waveguide apparatus and can, for example, be made of a transparent plastics material. Light can be guided into the luminous surface 339 via an optical waveguide 337 so that a light marker 345 is generated on the blocking beam 363. The optical waveguide 337 is optically continued via an optical waveguide 335 on the rotational receiving portion 364 side. The optical waveguide 335 is continued by an optical waveguide 333 in the base plate 365 at a coupling point 353 in the plane between the base plate 365 and the rotary plate 367. This is particularly applicable when the rotational position of the blocking beam 363 is selected similarly to a covering of the corresponding optical waveguide at the coupling point 353, i.e., in a blocking position (see FIG. 4). Via a lighting module 331, lighting can thus be generated which, when the blocking beam 363 is in the appropriate position, can then be converted into the light marker 345 by the optical waveguide 333, the optical waveguide 335, the optical waveguide 337, and the luminous surface 339. A controller 351 controls the lighting module 331 in this case.

It should lastly be noted that the corresponding arrangements in the examples shown can each be combined with one another and/or can be replaced with respective, differently designed blocking beams or combined with one another in different systems so that, for example, projection of a light marker 145 via the luminous cone 143 can also be combined with a directly generated light marker 245 via a lighting module 231 arranged in the blocking beam. Projection of standard text or images onto a corresponding blocking beam can similarly also be used on the blocking beam 363 of the barrier system 301. This also applies to other possible combinations. Generating a light marker via UV light on a fluorescent surface of a blocking beam and/or generating a heat signature via UV light can also be combined with each of these examples.

The present invention is not limited to embodiments described herein; reference should be had to the appended claims.

### LIST OF REFERENCE NUMERALS

101 Turnstile system
103 Ground
105 Wall
107 Pillar
109 Passage
111 Turnstile
121 Installation surface
123 Angle
131 Lighting module
133 Luminous bar
135 Luminous surface
137 Lighting module
141 Light signal
143 Luminous cone
144 Luminous cone
145 Light marker
151 Controller
153 Rotary sensor
155 Cable
156 Cable
157 Cable
163 Blocking beam
164 Blocking beam
165 Base plate
167 Hub
201 Turnstile system
203 Ground
205 Wall
207 Pillar
209 Passage
211 Turnstile
221 Installation surface
223 Angle
231 Lighting module
245 Light marker
251 Controller
253 Rotary sensor
257 Cable
258 Slip ring
259 Cable
263 Blocking beam
264 Blocking beam
265 Base plate
267 Rotational receiving portion
301 Barrier system
303 Ground
305 Post
307 Pillar
309 Passage
311 Barrier
331 Lighting module
333 Optical waveguide
335 Optical waveguide
337 Optical waveguide
339 Luminous surface
345 Light marker
351 Controller
353 Coupling point
363 Blocking beam
364 Rotational receiving portion
365 Base plate
367 Rotary plate

1-10. (canceled)

11. A device for separating at least one of persons and vehicles in a separating region, the device comprising:
a holding apparatus which is installable in a stationary manner;
a rotational receiving portion which is rotatable in a rotational plane about a rotational axis relative to the holding apparatus, the rotational receiving portion comprising at least one blocking beam receiving portion;
at least one blocking beam; and
a lighting apparatus comprising a light source which is assigned to the at least one blocking beam, the light source being configured to generate a light marker in an activated state and being arranged to mark a relevant blocking beam of the at least one blocking beam,
wherein,
the at least one blocking beam is configured to be received in a relevant blocking beam receiving portion of the at least one blocking beam receiving portion of the rotational receiving portion corresponding to the relevant blocking beam of the at least one blocking beam so that, when the rotational receiving portion rotates in the rotational plane about the rotational axis, the at least one blocking beam is pivoted out of the separating region so that at least one of a person and a vehicle can be separated from at least one of other persons and other vehicles upon a passage or a transit through the separating region.

12. The device as recited in claim 11, wherein,
the light source is arranged at least one of inside the relevant blocking beam and on the relevant blocking beam, and
the light marker is generated directly by the light source so as to mark the relevant blocking beam.

13. The device as recited in claim 11, wherein,
the light source is arranged at least one of outside the relevant blocking beam and separate from the relevant blocking beam, and
in the activated state, the light source projects the light marker onto the relevant blocking beam so as to mark the relevant blocking beam via the light marker so projected.

14. The device as recited in claim 13, wherein the light source is arranged at least one of on the holding apparatus and on the rotational receiving portion.

15. The device as recited in claim 11, wherein,
the light source comprises a control apparatus,
the control apparatus comprises a position sensor which is configured to determine a blocking beam position of the relevant blocking beam, and
the light source marks the relevant blocking beam via the control apparatus based on the blocking beam position.

16. The device as recited in claim 15, wherein,
the control apparatus further comprises an optical waveguide which is assigned to the light source,
a further optical waveguide is assigned to the light marker, and
the control apparatus is further configured to provide at least one of an electrical control, an electronic control, a mechanical control and an optical control so that, when the optical waveguide of the control apparatus which is assigned to the light source is combined with the further optical waveguide which is assigned to the light marker based on a rotational position of the rotational receiving portion, the light marker is generated via a guiding the light from the light source to the light marker.

17. The device as recited in claim 16, wherein the control apparatus is an opto-mechanically controlling control apparatus which is arranged in the rotational receiving portion.

18. The device as recited in claim 15, wherein the light source is multi-colored so that the light source generates a multi-colored light marker.

19. The device as recited in claim 18, wherein the control apparatus is configured to switch the multi-colored light marker generated by the light source.

20. The device as recited in claim 11, wherein the light marker generated by the light source is provided as at least one of a text display and an image display.

21. The device as recited in claim 11, wherein the light source comprises at least one of an LED light source, a laser light source, and a projection light source.

22. The device as recited in claim 11, wherein the at least one blocking beam is a barrier.

23. The device as recited in claim 22, wherein the barrier is provided to separate vehicles.

24. The device as recited in claim 11, wherein,
at least one blocking beam comprises at least two blocking beams which comprise a first blocking beam and a second blocking beam, and
the first blocking beam is pivoted out of the separating region and the second blocking beams is pivoted into the separating region when the rotational receiving portion rotates in the rotational plane about the rotational axis so that one person can be separated from other persons via the at least two blocking beams.
